(19) United States
(12) Patent Application Publication
(10) Pub. No.: US 2014/0114748 A1
(43) Pub. Date: Apr. 24, 2014

(54) Determining Advertising Effectiveness Bases on a Pseudo-Control Group

(71) Applicant: Sean Michael Bruich, Palo Alto, CA (US)

(72) Inventor: Sean Michael Bruich, Palo Alto, CA (US)

(21) Appl. No.: 13/658,536

(22) Filed: Oct. 23, 2012

(51) Int. Cl. G06Q 30/02; G06Q 50/00

(52) U.S. Cl. CPC G06Q 30/0246; G06Q 50/01
USPC 705/14.45

(57) ABSTRACT

Actions and/or behaviors of social networking system users are observed and used for measuring advertising effectiveness. More specifically, advertisements from an advertising campaign are selectively targeted and presented to specific subsets of social network users and withheld from other subsets of social network users. After the advertisements are presented, actions performed by users in the different subsets are be identified and analyzed to determine metrics describing the effectiveness of the particular advertising campaign. In one aspect, the metrics are based on a pseudo-control group.

### BACKGROUND

This invention generally pertains to social networking, and more specifically to determining advertising effectiveness based on a pseudo-control group.

Many businesses expend significant resources on advertising campaigns promoting their products, services, or brands. A typical advertising campaign includes an advertising objective and includes one or more advertising messages communicated to potential customers to meet the objective. One objective of an advertising campaign may be to increase the awareness of a product, service, or brand. Another objective may be to generate favorable opinions for a product, service, or brand. Often, advertisers communicate advertisements from an advertising campaign to potential customers using various forms of media including television, newspapers, radio, cinema, billboards, the Internet and/or the like. Distributing advertisements via the Internet rather than more conventional distribution channels is becoming increasingly popular among advertisers.

Advertisers are typically interested in measuring the effectiveness of their advertising campaigns. Accurate measurement of the effectiveness of an advertising campaign allows an advertiser to understand the return on investment (ROI) of their advertising and allows the advertiser to adjust its marketing strategy if necessary. However, accurately measuring the effectiveness of an advertising campaign requires a controlled environment including a control group that is not presented with advertisements from the advertising campaign. This control group, or “holdout subset” is difficult to achieve in practice as attempts to develop the holdout subset typically suffers from selection bias.

For example, an advertiser may roll out an advertising campaign on local television shows in one city and not run the advertising campaign in a different city. Thereafter, the advertiser may, using phone surveys, measure the difference between the two cities with respect to an awareness of or preference for the product, service, or brand being advertised by the advertising campaign. However, baseline differences between the populations of the different cities independent of exposure to the advertisements of the advertising campaign can influence the awareness of or preference for the product, service, or brand of the advertising campaign. For example, due to demographic differences between the populations of the two cities, users in one city may be biased towards a product compared to users of the other city. Because of the various factors possibly affecting the awareness of or preference for products, services, or brands, measuring the effectiveness of advertising campaigns using traditional techniques often results in skewed and inaccurate measurements.

### SUMMARY

Embodiments of the invention analyze data of social networking system users to more accurately measure advertising effectiveness. One or more advertisements are selected from an advertising campaign, and the selected advertisements are targeted and presented to specific subsets of social networking system users while being withheld from other subsets of social networking system users. Following presentation of the advertisements, various online actions (e.g., searches, likes, shares, group joins, purchases, etc.) and offline actions of the users in the subsets are observed. Other data may also be obtained. The observed actions and/or other data may be compared, contrasted, and/or analyzed between the subsets to measure the effectiveness of the advertisements or the advertising campaign.

In one embodiment, a social networking system randomly or pseudo-randomly assigns or selects its users for one or more user subsets. Membership in a subset determines, in part, the advertisements that a user sees from a particular advertising campaign, if any. Specifically, if a user belongs to a subset designated as a sample subset, the user may be eligible to be presented with advertisements from the advertising campaign. In one embodiment, an advertisement may include content identifying a brand, product, or service that an advertiser is trying to promote. Conversely, if a user belongs to a subset designated as a holdout subset, advertisements from the advertising campaign are withheld from or prevented from being presented to the user. Because the users of the sample subset and the holdout subset are randomly or pseudo-randomly assigned, the characteristics between the two subsets are likely to be statistically similar or statistically identical.

After selection of the subsets, advertisements of the advertising campaign are presented to users in the sample subset. As discussed, advertisements are withheld from presentation from users in the holdout subset. Thereafter, the social networking system observes, at least, the actions or behaviors of the users in the sample subset and the holdout subset. In one embodiment, the social networking system may determine each time the users in the sample subset and the holdout subset searched, shared, commented on, liked, wanted, joined groups associated with and/or viewed content related to the advertisements. For example, the social networking system determines when users searched for fan pages for an advertised product. As another example, the social networking system determines purchases associated with products, services or brands related to the advertising campaign being analyzed. The observed actions or behaviors of the users in the sample subset and the holdout subset are compared and a measure of the advertisements' or advertising campaign's effectiveness is computed from the comparison.

Using holdout subsets and sample subsets made up of the users of a social networking system allows advertisers to obtain accurate measurements of advertising campaign and/or advertisement effectiveness. Because a social networking system maintains a rich data set describing the characteristics and actions of its users, it is capable of generating well-defined holdout subsets where the influence of factors other than exposure to advertisements can be mitigated. This allows social networking systems to create highly controlled environments capable of accurately measuring advertising effectiveness.

Further, comparing user actions allows more accurate measurement of advertising effectiveness. Certain user actions are highly correlated with brand/product/service awareness and/or favorability. For example, a user “liking” the fan page of a product in a social networking system is highly correlated with a favorable perception of the product by the user. Thus, by observing and comparing actions of social networking system users in a sample subset and in a holdout subset, more accurate measurements of advertising effectiveness may be derived.

In another embodiment, the holdout subset is compared to a pseudo-control group rather than to the sample subset. The pseudo-control group may then be used as a control against which the sample subset is compared in order to measure advertising effectiveness. In one implementation, the pseudo-control group includes users in the sample subset that were not presented with the advertisements. More specifically, the pseudo-control group includes users in the sample subset that did not meet specific targeting criteria (e.g., demographic criteria, interest criteria, behavioral criteria), etc. for being shown advertisements. However, because such users were not randomly selected, the pseudo-control group cannot be considered a true control group. In another implementation, the pseudo-control group includes users external to or not known to be associated with the social networking system. In one aspect, the users external to the social networking system included in a pseudo-control group may not be users of a particular online entity (e.g., a website) but may be people, households, or other entities about which an advertiser has information (e.g., purchase transaction data). For purposes of illustration in this disclosure, such persons or households may be referred to as users.

Put another way, the pseudo-control group includes users that are primarily defined as not having been exposed to or presented with the advertisements. Other characteristics of the users in the pseudo-control group may not be controlled or known. In one aspect, various modeling approaches or applied weights are employed to make the pseudo-control group statistically more similar or identical to the sample subset. The pseudo-control group is then compared to the holdout subset in order to validate that the pseudo-control group is indeed similar or identical to the sample subset. As a result, it can be ensured that the pseudo-control group is able to act as a suitable control with which the sample subset can be compared in order to measure effectiveness of the advertisements.

In one aspect, the pseudo-control group may be larger than the holdout subset. For example, the pseudo-control group may include five, ten, or twenty times more users than the holdout subset. The holdout subset may include a number of users that is any suitable percentage of the combined number of users of the holdout subset and the sample subset. For example, the holdout subset may include 10%, 5%, 1%, or 0.1% of the combined number of users of the holdout subset and the sample subset.

In one implementation of the embodiment, to generate metrics, relevant data (e.g., purchase transaction data, observed behaviors, polling data, etc.) for users in the pseudo-control group and similar data for users in the holdout subset are compared. If differences between the data of the pseudo-control group and the data of the holdout subset are within a particular similarity range, effectiveness of the advertising campaign or advertisements may be determined by comparing the pseudo-control group to the sample subset. However, if the differences between the pseudo-control group data and the holdout subset data fall outside of the similarity range, an indication may be provided that determining the effectiveness of the advertising campaign or advertisements by comparing the sample subset to the pseudo-control group may be skewed and inaccurate. In one embodiment, advertising campaign or advertisement effectiveness is not determined if the pseudo-control group data and the holdout subset data differ by more than the similarity range.

Using small holdout subsets and larger pseudo-control groups as described reduces the number of wasted advertising opportunities. Because holdout subsets primarily serve as checks for whether pseudo-control groups can be suitably compared to sample subsets, holdout subsets may be kept relatively small in size. Reducing the sizes of holdout subsets increases the sizes of the sample subsets, allowing more users to be exposed to advertisements from an advertising campaign.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high level block diagram illustrating a system environment suitable for operation of a social networking system, in accordance with an embodiment of the invention.

FIG. 2 is a block diagram of various components of a social networking system, in accordance with an embodiment of the invention.

FIG. 3 illustrates the use of a hash function to determine if a user identifier belongs to a particular subset of user identifiers, in accordance with an embodiment of the invention.

FIG. 4 is a flow chart of a process for determining the effectiveness of advertising based on the observed actions of users in accordance with an embodiment of the invention.

FIG. 5 is a flow chart of a process for determining the effectiveness of advertising by using a pseudo-control group in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system by registering for an account. Thereafter, the social networking system can reliably determine the user based on the user account.

In one embodiment, the social networking system stores information related to each user as part of a user profile. Such information related to a user can be used to selectively target the user for various advertising campaigns. The user profile may store any suitable information about a user, such as the user's demographics, including gender, age, geographical region, stated interests or preferences, professional, personal, or educational affiliations, income, etc. The user profile may also be associated with historical information regarding the activities of the user internal to and/or external to the social networking system. For example, the user profile may be associated with information regarding a user's visits to various fan pages, searches for fan pages, liking fan pages, becoming a fan of fan pages, sharing fan pages, liking advertisements, commenting on advertisements, sharing advertisements, joining groups, attending events, checking-in to locations, buying a product, etc. These are just a few examples of the information that may be stored by and/or associated with a user profile. Other types of information are also possible.

The user profile may also maintain information indicating different social network connections (e.g., friends, family members) for a user. For example, a first user can accept requests from other users of the social networking system to become connections of the first user. After the first user accepts the requests, the social networking system may store information indicating those other users to which the user is now connected in the social networking system in the first user's profile.

As discussed, a social networking system can be configured to observe the actions or behaviors of its users in order to accurately measure advertising effectiveness. More specifically, one or more advertisements are selected from an advertising campaign, and the selected advertisements are targeted and presented to specific subsets of social networking system users while being withheld from other subsets of social networking system users. Following presentation of the advertisements, various online actions (e.g., searches, likes, shares, group joins, purchases, etc.) and offline actions of the users in the subsets are observed. The observed actions and/or other data may be compared, contrasted, and/or analyzed between the subsets to measure the effectiveness of the advertising campaign or advertisements.

### System Architecture

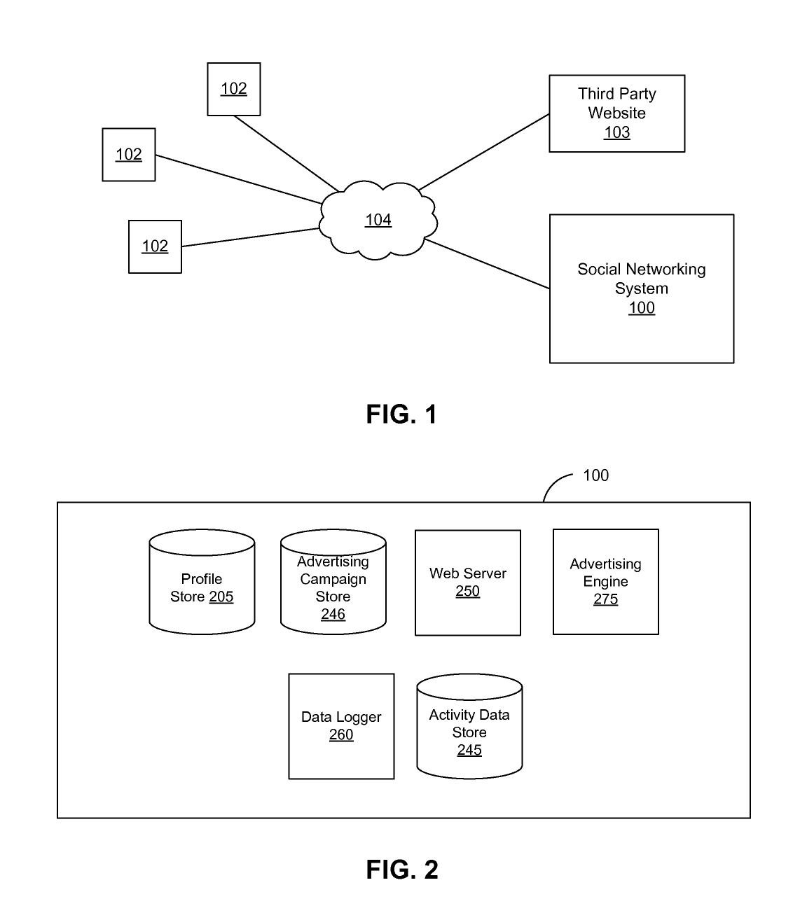

FIG. 1 is a high level block diagram illustrating a system environment suitable for operation of a social networking system 100. The system environment includes one or more client devices 102, one or more third-party websites 103, a social networking system 100, and a network 104. While FIG. 1 shows three client devices 102 and one third-party website 103, it should be appreciated that any number of these entities (including millions) can be included. In alternative configurations, different entities can also be included in the system environment.

The client devices 102 include one or more computing devices that can receive user input and can transmit and receive data via the network 104. For example, the client devices 102 may be desktop computers, laptop computers, tablet computers (pads), smart phones, personal digital assistants (PDAs), or any other devices including computing functionality and data communication capabilities. The client devices 102 are configured to communicate via network 104, which may be any combination of local area and/or wide area networks using both wired and wireless communication systems. For example, the network 104 may be any combination of the Internet, a mobile network, a LAN, a wired or wireless network, a private network, a virtual private network and/or any other suitable communication mechanisms. The client devices 102 may provide an interface by which various users can communicate with the social networking system 100. The third party website 103 is coupled to the network 104 in order to communicate with the social networking system 100 and/or with one or more client devices 102.

The social networking system 100 includes a computing system that allows its users to communicate or otherwise interact with each other and access content as described herein. In one embodiment, the social networking system 100 stores user profiles that describe social networking system users, including biographic, demographic, and other types of descriptive information, such as work experience, educational history, hobbies or preferences, location, and the like. The social networking system 100 additionally stores other objects, such as fan pages, events, groups, advertisements, general postings, etc.

FIG. 2 is an example block diagram of various components of one embodiment of the social networking system 100. The social networking system 100 includes a web server 250, an advertising campaign store 246, a profile store 205, a data logger 260, an activity data store 245, and an advertising engine 275. In alternative configurations, different and/or additional components can be included in the system 100.

In general, the web server 250 links the social networking system 100 via the network 104 to one or more of the client devices 102, as well as to one or more third party websites 103. The web server 250 may include a mail server or other messaging functionality for receiving and routing messages between the social networking system 100 and the client devices 102 or third party websites 103. The messages can be instant messages, queued messages (e.g., email), text and SMS messages, or any other suitable messaging technique. In one embodiment, the web server 250 can receive user requests for content, where the content is to be provided with one or more advertisements. In response, the web server 250 may provide the content and one or more advertisements to the user. The selection of the advertisements may be subject to whether the user is part of one or more holdout subsets associated with the advertisements, as described herein. The web server 250 may also facilitate user actions over the social networking system, and provide information regarding the actions to the data logger 260.

The advertising campaign store 246 stores structures describing one or more advertising campaigns. An advertising campaign structure stores information identifying an advertiser, a name or description of the advertising campaign, one or more advertisements, and parameters for the number of users to be included in the sample and holdout subsets. An advertising campaign may also specify targeting criteria for selecting users to receive the campaign's advertisements or other data specifying the scope of the advertising campaign. In one embodiment, the targeting criteria may be associated with specific advertisements in the campaign, allowing use of different criteria for selecting different advertisements from a campaign. An advertisement may be targeted towards users based on attributes stored in the user profile for each user maintained by the social networking system 100. For example, targeting criteria may select a user based on the user's demographics, including gender, age, geographical region, stated interests or preferences, professional, personal, or educational affiliations, income or other data included in a user profile associated with the user. Different types of user affiliations may be specified by targeting criteria, such as memberships in groups, lists, networks, forums, clubs within the social networking system. For example, an advertisement may be targeted towards women younger than 30 years of age, living in the San Francisco Bay area, graduates from a list of specific colleges and universities, and members of a specific group maintained by the social networking system 100.

The targeting criteria of an advertisement campaign may also specify attributes of the user's actions within or outside of the social networking system (or a combination of both). Example targeting criteria based on user actions include frequency of use of the social networking system 100, length of time logged-in to the social networking system 100, access or use of specific features of the social networking system 100 or destinations outside the social networking system 100. For example, an advertisement may be targeted to users who used the system at least five times per week for the past month and who have used a gift giving application within the last three days. Hence, the targeting criteria can comprise any data available to the social networking system and can be combined in any manner.

An advertisement can be associated with parameters used to determine effectiveness of an advertising campaign or the advertisement. Examples of parameters include: a time interval during which advertisements associated with the advertising campaign are shown to users, the order in which advertisements are shown, or locations of advertisements if the campaign allows or requires different advertisements to be shown in different locations. Variations in an advertising campaign may be identified by varying the parameters associated with the advertisements that make up the campaign and analyzing the effect of the variances. For example, an optimal duration for presenting an advertisement to a user can be determined by varying time intervals for presenting the advertisement.

As discussed, an advertisement identifies a brand, product, or service that an advertiser is trying to promote. An advertisement may include one or more images, videos, audio, software applications, and/or textual information. Hyperlinks to websites or fan pages providing information related to the brand, product, or service being advertised may be included in the advertisement, and the hyperlinks may be associated with the images, videos, audio, software applications, or textual information in the advertisement. Information from the social networking system 100, such as user comments, likes, etc. may be retrieved and presented by or in conjunction with the advertisement.

In some embodiments, advertisements include input elements, such as buttons or links, allowing interaction with the advertisements by viewing users. For example, an advertisement may include a like button allowing a user to indicate a positive perception of the advertisement to other social networking system users (e.g., friends of the user in the social networking system) by interacting with the like button. As another example, an advertisement may include a share button allowing a user to share the advertisement with other social networking system users by interacting with the share button. As still another example, an advertisement may include a comment field allowing a user to provide a comment on the advertisement that is shared with other social networking system users.

The profile store 205 stores user profiles for social networking system users. Each user profile may include demographic and other information associated with a particular user, such as the user's gender, age, geographical location, education or professional affiliations, group memberships, interests, activities, income, nationality, race, and/or the like. For example, a profile stored in the profile store 205 may indicate that a particular user is 25 years old, lives in Cheyenne, works as a doctor, and enjoys horseback riding. In one embodiment, each user profile may also include information about its associated user's connections in the social networking system 100 to other social networking system objects and/or users.

The data logger 260 receives communications from the web server 250 regarding different actions or activities of social networking system users. For example, the data logger 260 receives data from the web server 250 indicating when users of the social networking system 100 have shared, liked, commented on, joined a group related to, viewed, and/or searched for content (e.g., fan pages). The data received by the action logger 260 may include information describing the actions and/or the object on which the actions were performed, allowing identification of actions and/or objects associated with an advertising campaign and/or an advertisement. In one embodiment, data received by the data logger 260 is stored in the activity data store 245. For example, when a new action is received from the web server 250, the data logger 260 generates a new instance of an activity object in the activity data store 245, assigns a unique identifier to the activity object, and populates the activity object with information describing the received action. In some embodiments, the stored data may be stored anonymously so that users performing the actions cannot be personally identified.

The advertising engine 275 determines the effectiveness of advertisements or advertising campaigns based on the observed actions of users. In one embodiment, the advertising engine 275 compares the observed actions of users included in a sample subset and users included in a holdout subset. Based on the comparison, metrics measuring the effectiveness of the advertisements or an advertising campaign can be determined. In another embodiment, the advertising engine 275 compares data (e.g., observed actions, polling data, transaction data, etc.) of users included in a pseudo-control group and users included in a holdout subset. If the differences between the data of the pseudo-control group and the sample subset are within a certain similarity range, the pseudo-control group is compared to a sample subset in order to generate metrics measuring advertising effectiveness.

In one embodiment, a particular advertising campaign may have several different sample subsets. Generally, the sample subsets for an advertising campaign are variable based upon the selection of the advertisements for presentation to users in the sample subsets, the order of presentation, and the manner of presentation (e.g., location on page, size, etc.) or any other technique or variation. For example, one holdout subset that is not shown any advertisements from an advertising campaign is defined. Additionally, a first sample subset that can be exposed to three specific advertisements in order A, B, C is defined, a second sample subset shown only advertisements A and C is defined, and a third sample subset shown the three specific advertisements in reverse order C, B, A is defined. Other experimental subsets may be generated by varying other characteristics of the advertisement, for example, location of the advertisement within a web page or other user interface used for showing the advertisement or the duration for which the advertisement is presented to the member. The holdout subset and the sample subsets are maintained independent of each other. Comparisons based on the observed actions of users in different subsets may be used to determine different measures of advertisement effectiveness. For example, comparing actions performed by users in a sample subset and in a holdout subset allows determination of the effectiveness of the advertisement; comparing actions performed by users in different sample subsets allows evaluation of the effectiveness of two different versions of the advertisement or of different advertisement presentation techniques. For ease of understanding, the remaining disclosure will primarily discuss the comparison of a single sample subset of an advertising campaign to a holdout subset.

### Method for Determining the Effectiveness of Advertising Based on Observed Actions

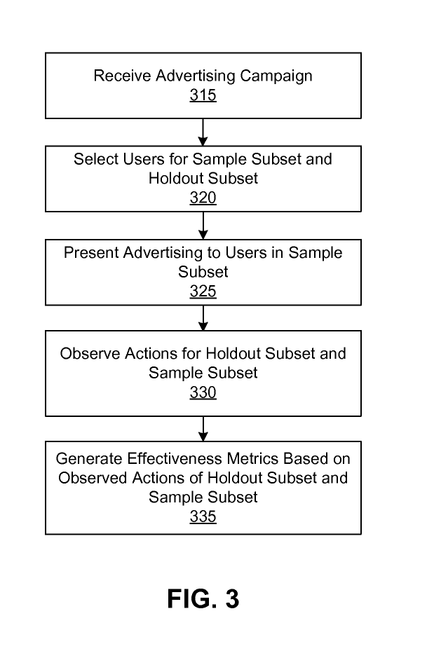

FIG. 3 illustrates one embodiment of a process for determining the effectiveness of advertising based on observed actions. In one embodiment, the process receives 315 an online advertising campaign to be presented to users. Thereafter, the process randomly (or pseudo-randomly) assigns or selects 320 at least some of its users for inclusion in one of a sample subset or a holdout subset for the given advertising campaign. In one embodiment, the process assigns users to a subset by computing a hash value for each user based on an identifier for the user and on an identifier for the given advertising campaign. The output of the hash function determines whether a user is assigned to the sample subset or to the holdout subset for the advertising campaign.

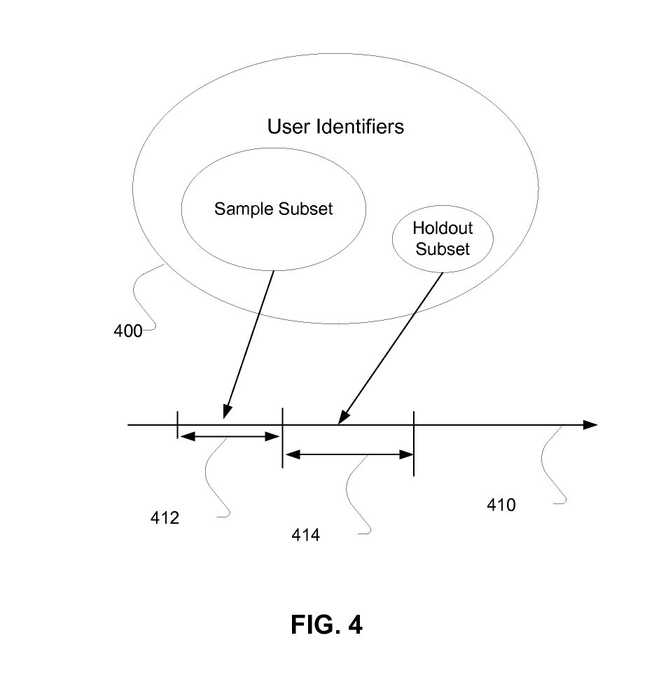

FIG. 4 illustrates an example of using a hash function to assign a user to either a sample subset or a holdout subset. In FIG. 4, the set 400 is the overall set of all user identifiers stored in the profile store 205 of the social networking system 100. For example, the set 400 includes 1,000,000 user identifiers corresponding to 1,000,000 different users. The process retrieves a user identifier from the set 400 and applies a hash function to the user identifier and to an advertising campaign identifier for a given advertising campaign. In one embodiment, the hash function is the MD5 hashing algorithm combined with a modulo operator, for example, md5(x) % K where md5 is the MD5 hash function, x is the input to the MD5 hash function, and K is a predetermined constant.

Applying the hash function to the user identifier and the advertising campaign identifier produces a hash value for the user identifier of the set 400. The hash value is included in a set 410 of hash values. The process associates different ranges within the set 410 of hash values with different subsets. In the example of FIG. 4, if the hash value is within a sample range 412 of hash values, the user identifier is included in a sample subset. If the hash value is within a holdout range 414 of hash values, the user identifier is included in a holdout subset. The sample range 412 and or the holdout range 414 may be specified by an advertiser or a system operator to control the number of users included in each subset.

Thereafter, the process presents 325 an advertisement from the advertising campaign to users in the sample subset. The process additionally withholds the advertisement from users in the holdout subset. For example, an advertisement from the advertising campaign is selected for presentation to a user, and it is determined if the user is in the holdout subset. If the user is in the holdout subset, the selected advertisement is withheld from being presented to the user and a different advertisement is selected for presentation to the user. However, if the user is not in the holdout subset and is in the sample subset, the selected advertisement is presented to the user.

After presenting the advertisement to users in the sample subset, the process observes 330 the actions for users in the holdout subset and the sample subset. The observed actions may occur within the social networking system 100 and/or external to the system. To observe user actions, the process may access the activity data store 245 and determine actions performed by users in the sample subset and actions performed by users in the holdout subset. For example, the process determines the number of users from the sample subset that performed a specific action, such as liking or commenting on the advertisement, and determines the number of users from the holdout subset that performed the same specific action. As an example, an advertisement that is presented to the sample subset promotes an automobile manufacturer's newest car. The process determines, from the activity data store 245, the number of users in the sample subset and the number of users in the holdout subset that have searched for a fan page of the manufacturer.

In one embodiment, the process may determine actions of users in the sample subset and users in the holdout subset where the users of the subsets communicate information about the advertisement to other users in the social networking system 100. For example, the process may identify the transmission of a social story from a user of the sample subset to the user's friends. The social story may report an action performed by the user on the advertisement or on an entity (e.g., a fan page) associated with the advertisement. The social story may additionally include the advertisement or the content related to the advertisement.

In one embodiment, the process determines actions performed by users in the sample subset or by users in the holdout subset that occurred over a specified period of time following presentation of the advertisement and/or the advertising campaign. For example, the process determines actions occurring within an hour, a day, a week, a month, or a year after initial presentation of the advertisement and/or advertising campaign.

The process may also receive polling data from users in the sample subset and/or users in the holdout subset. For example, the process may provide questions to users in the various subsets to obtain additional information about user perception of advertisements. For example, questions ask the users for impressions about the presented advertisement, impressions about a brand, product, or service associated with the advertisement or other information describing user sentiment toward the advertisement. Users' responses to questions are received by the process and used when determining advertisement or advertising campaign effectiveness.

In some embodiments, the process may additionally receive purchase transaction data for users in the sample subset and/or users in the holdout subset. The transaction data may be provided subject to user-specified privacy settings specified in user profiles, allowing individual users to regulate the amount of their transaction data accessible to the social networking system 100. The transaction data allows the process to determine the number of users in various subsets that purchased products or services promoted by, or otherwise related to, an advertisement.

Upon observing the actions, the process generates 335 one or more metrics indicative of the effectiveness of the advertisement or advertising campaign. In one embodiment, the process determines effectiveness metrics that directly compare the observed actions of all or any combination of the users in the sample subset to the observed actions of users in the holdout subset. For example, the metrics may be generated based on a comparison between the observed actions of users in the sample subset actually presented with an advertisement (referred to as a “viewing group”) and the observed actions of users in the holdout subset.

In one embodiment, the process can calculate lift metrics. A lift metric may indicate the percentage change in awareness or favorability towards a brand, product, or service as a result of the advertisement. For example, assume that the favorability of users in the holdout subset is computed to be x1 and the favorability of sample subset is computed to be x2, the lift value L for a metric related to favorability may then be calculated as:

$$L = \frac{x 2 - x 1}{x 1} \times 100 \% \qquad ( 1 )$$

Hence, the lift metric L measures an improvement in the favorability towards a brand, product, or service as a result of the sample subset being presented an advertisement. In other embodiments, the process performs different types of statistical analysis, such as using z-test to determine the statistical significance of responses to a question.

The input values (i.e., x2 and x1 of equation 1) for calculating a lift metric may be based on the observed actions of the sample subset and of the holdout subset. For example, when computing a lift metric for awareness, the process computes the input value for the holdout subset from the number of searches for, shares of, likes of, joining groups related to, and/or comments on content for a product, service or brand associated with the advertisement performed by users in the holdout subset. The input value for the sample subset may be similarly computed. Hence, a total number of actions relating to content for a product, service or brand associated with the advertisement may be calculated for each of the sample and holdout subsets, and used to determine the lift metric.

Similarly, when computing a lift metric for favorability, the process computes the input values for users in the holdout subset and for users in the sample subset based on the number of actions performed by users in each subset that are indicators of positive feedback. For example, the number of times users have liked, joined groups related to, and/or positively commented on content for a product, service or brand associated with the advertisement are computed. Each of the aforementioned actions may be indicative of positive feedback. The input value for the holdout subset may be the total number of actions indicating positive feedback performed by users in the holdout subset; similarly, the input value for the sample subset may be the total number of actions indicative of positive feedback performed by users in the sample subset. Polling data and/or transaction data may also be used when determining input values for the sample subset and for the holdout subset.

A sample result obtained for an advertisement is shown in the following table:

TABLE 1

| | Improvement in Product | |
|---|---|---|
| Number of Impressions | Awareness | Brand Favorability |
| 1-5 | a1 % | b1 % |
| 6-10 | a2 % | b2 % |

In Table 1, the column titled “Number of Impressions” includes different ranges of number of times the advertisement is presented to users in the sample subset. The additional columns in Table 1 identify lift metrics for product awareness and brand favorability corresponding to the different ranges of advertisement presentation.

### Method for Determining the Effectiveness of Advertising by Using a Pseudo-Control Group

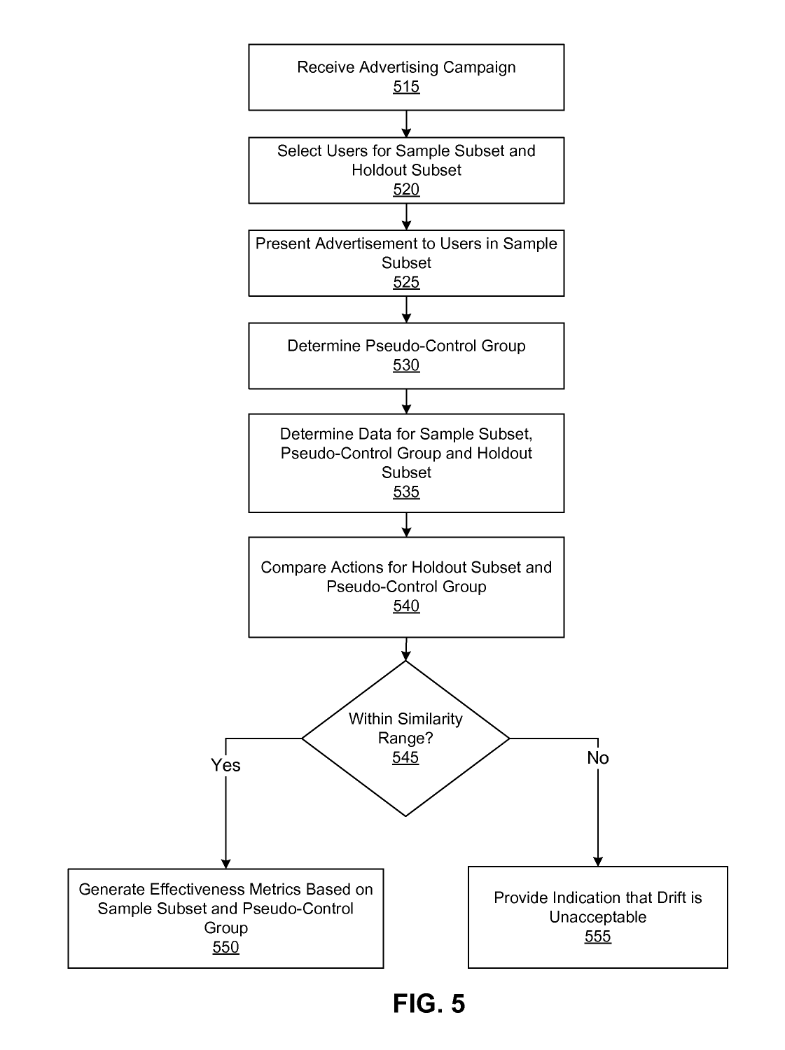

FIG. 5 illustrates one embodiment of a process for determining the effectiveness of advertising by using a pseudo-control group. In one embodiment, the process receives 515 an advertising campaign to be presented to users. Thereafter, the process randomly (or pseudo-randomly) assigns or selects 520 at least some of its users for inclusion in one of a sample subset or a holdout subset. The holdout subset may include a number of users that is any suitable percentage of the combined number of users of the holdout subset and the sample subset. For example, the holdout subset may include 10%, 5%, 1%, or 0.1% of the combined number of users of the holdout subset and the sample subset. Thereafter, the process presents 525 an advertisement of the campaign to users in the sample subset. In addition, the advertisement can be withheld from presentation to users in the holdout subset. In one embodiment, the assignment of users to the various subsets, and the presentation of the advertisement to the users can proceed in a manner similar to that described with respect to the process of FIG. 3.

The process additionally determines 530 a pseudo-control group. The pseudo-control group can include a set of users who were not presented with the advertisement. The pseudo-control group may include users who are (1) part of a group of users in the sample subset who were not presented with the advertisement or (2) users external to or not known to be associated with the social networking system and who were not presented with the advertisement. The pseudo-control group can include five, ten, twenty, or more times of users than the holdout subset.

After determining the pseudo-control group, the process determines 535 relevant comparison data for users in the holdout subset, sample subset, and/or pseudo-control group. For example, the determined data may include purchase transaction data specifying purchases for the product or services promoted by the advertisement by those in the holdout subset, sample subset, and/or pseudo-control group. For example, the purchase transaction data may indicate the number of times users in the pseudo-control group purchased a product advertised by the advertisement for a year prior to presentation of the advertisement and the number of times users in the pseudo-control group purchased the product for six months after presentation of the advertisement.

The data can additionally include the observed actions of the holdout subset, sample subset, and/or pseudo-control group in the social networking system 100. The observed actions of the users may be determined in a manner similar to the identification of observed actions described with respect to the process of FIG. 3. The data can moreover include polling data obtained from the holdout subset, sample subset, and/or pseudo-control group.

After determining the data, the process compares 540 the data of the holdout subset with the data of the pseudo-control group. In comparing the data associated with the pseudo-control group and similar data of the holdout subset, the process calculates a drift metric, which represents the differences between the data of the holdout subset and the data of the pseudo-control group. For example, the drift metric may be based on the number of times users in the holdout subset purchased a product related to the advertisement and the number of times users in the pseudo-control group purchased the same product related to the advertisement. In other embodiments, the drift metric may be based on other data including polling data from, the observed online actions of, and the observed offline actions of users in the holdout subset and in the pseudo-control group, etc.

The process then determines 545 if the drift metric is within an acceptable similarity range. If the drift metric is within the similarity range, the process generates 550 effectiveness metrics for the advertisement or advertising campaign. In one embodiment, the process generates the effectiveness metrics based on comparisons of the data of the pseudo-control group and the sample subset. The comparison can be performed between the data of the pseudo-control group and data for all or any combination of users in the sample subset. For example, the process may generate an effectiveness metric based on comparisons of the data of the pseudo-control group and the data of users in the sample subset actually presented with the advertisement (i.e., the viewing group of the sample subset). Computation of the effectiveness metrics may be performed as described above with respect to the process of FIG. 3. For example, lift metrics may be calculated based on data (e.g., transaction data, polling data, observed action data, etc.) for the sample subset and for the pseudo-control group.

If the drift metric is not within the similarity range, the process provides 555 an indication that the pseudo-control group exhibits an unacceptable level of drift. The indication can further specify that any determined effectiveness metric for the advertisement or advertising campaign may be skewed or inaccurate.

In one embodiment, the drift metric may be continually or periodically updated based on additional data identified and/or received for the holdout subset and pseudo-control group. The updated drift metric is used to determine whether to compute additional effectiveness metrics comparing the sample subset and the pseudo-control group. This allows continual or periodic monitoring of the pseudo-control group to ensure that it is suitable for use as a control group for the sample subset over time.

In one embodiment, a single pseudo-control group is used to generate advertising effectiveness metrics across several different advertising campaigns. Different advertising campaigns may be associated with different holdout subsets and effectiveness of the different advertising campaigns is determined by comparing the holdout subsets for each advertising campaign to the single pseudo-control group. In one embodiment, the process also provides information describing how the pseudo-control group drifts over time across the different advertising campaigns. In one embodiment, the pseudo-control group drift across the different advertising campaigns is used to determine different user characteristics or variables that may have led to the drift.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
selecting a holdout subset from a plurality of users of a social networking system, the holdout subset being associated with one or more advertisements;
selecting an advertisement from the one or more advertisements;
determining whether a user of the social networking system is in the holdout subset;
if the user is in the holdout subset, preventing the advertisement from being presented to the user;
if the user is not in the holdout subset, presenting the advertisement to the user;
selecting a pseudo-control group including a plurality of entities to which the one or more advertisements were not presented;
retrieving purchase transaction data related to the one or more advertisements for users of the social networking system not in the holdout subset, the users of the social networking system in the holdout subset, and the entities of the pseudo-control group;
generating a drift metric based on the purchase transaction data for the entities in the pseudo-control group and the purchase transaction data for users in the holdout subset, the drift metric describing a relative similarity between the pseudo-control group and the holdout subset;
determining whether the drift metric is within a similarity range; and
responsive to determining that the drift metric is within the similarity range, determining a measure of effectiveness for the one or more advertisements based at least in part on the purchase transaction data for the users not in the holdout subset and the purchase transaction data for the entities in the pseudo-control group.

2. The computer-implemented method of claim 1, further comprising responsive to determining that the drift metric is outside the similarity range, providing a notification that the measure of effectiveness may be skewed.

3. The computer-implemented method of claim 1, further comprising responsive to determining that the drift metric is outside of the similarity range, preventing determination of the measure of effectiveness.

4. The computer-implemented method of claim 1, wherein the entities of the pseudo-control group are persons and wherein the one or more persons of the pseudo-control group are not users of the social networking system.

5. The computer-implemented method of claim 1, wherein the entities of the pseudo-control group are persons and wherein the one or more persons of the pseudo-control group are users of online services external to the social networking system.

6. The computer-implemented method of claim 1, wherein the drift metric is further based on (1) one or more actions performed by the users of the holdout subset relating to content associated with the advertisement stored by the social networking system and (2) one or more actions performed by the entities of the pseudo-control group relating to content associated with the advertisement stored by the social networking system.

7. The computer-implemented method of claim 6, wherein an action performed by a user of the holdout subset is at least one of: a like action, a share action, a comment action, a search action, or a join action.

8. The computer-implemented method of claim 1, further comprising:
retrieving additional purchase transaction data for the users not in the holdout subset, the users in the holdout subset, and the entities of the pseudo-control group;
generating an updated drift metric based on the additional purchase transaction data for the entities of the pseudo-control group and on the additional purchase transaction data for the users of the holdout subset;
determining whether the updated drift metric is within the similarity range; and
responsive to determining that the drift metric is within the similarity range, determining an updated measure of effectiveness based at least in part on the additional purchase transaction data for the users not in the holdout subset and the additional purchase transaction data for the entities of the pseudo-control group.

9. The computer-implemented method of claim 1:
wherein the purchase transaction data for the entities of the pseudo-control group indicates a number of entities in the pseudo-control group that purchased a product associated with the one or more advertisements, and
wherein the purchase transaction data for the users of the holdout subset indicates a number of users in the holdout subset that purchased a product associated with the one or more advertisements.

10. The computer-implemented method of claim 1, wherein the drift metric is further based on polling data received from the users of the holdout subset and polling data received from the entities of the pseudo-control group.

11. A computer-implemented method comprising:
presenting an advertisement to a viewing group of users of a social networking system, the viewing group selected from users of the social networking system eligible to be presented with the advertisement, and not presenting the advertisement to a holdout subset comprising users of the social networking system not eligible to be presented the advertisement;
determining a pseudo-control group including users eligible to be presented with the advertisement that were not presented with the advertisement;
storing actions related to content associated with the advertisement performed by users in the viewing group, users in the holdout subset, and users in the pseudo-control group;
determining whether differences between the actions by users in the holdout subset and the actions by users in the pseudo-control group exceeds a defined threshold; and
responsive to determining the differences do not exceed the defined threshold, calculating a metric describing effectiveness of the advertisement based in part on the actions by users in the viewing group and the actions by users in the pseudo-control group.

12. The computer-implemented method of claim 11 wherein a number of users in the holdout subset is less than or equal to one percent of a number of users in the social networking system.

13. The computer-implemented method of claim 11, wherein the viewing group comprises users of the social networking system having at least one attribute that satisfies targeting criteria associated with the advertisement.

14. The computer-implemented method of claim 13, wherein the targeting criteria associated with the advertisement specifies user demographic information.

15. The computer-implemented method of claim 13, wherein the targeting criteria associated with the advertisement specifies a type of interaction between a user and another user in the social networking system.

16. A computer-implemented method comprising:
determining a control group associated with an advertisement, the control group including users of a social networking system not eligible to be presented with the advertisement;
determining a pseudo-control group including at least some entities that were not presented with the advertisement;
retrieving data associated with the advertisement for users in the control group;
retrieving data associated with the advertisement for users in the pseudo-control group;
retrieving data associated with the advertisement for users of the social networking system that are eligible to be presented with the advertisement;
determining whether differences between the data for the users in the control group and the data for users in the pseudo-control group are within a defined threshold;
responsive to determining that the differences between the control group and the pseudo-control group are within the defined threshold, determining a metric for effectiveness of the advertisement based on the data for the entities in the pseudo-control group and the data for the users in the social networking system that are eligible to be presented with the advertisement.

17. The computer-implemented method of claim 16, wherein the data for the users in the control group associated with the advertisement includes data for purchases of products or services associated with the advertisement made by users in the control group.

18. The computer-implemented method of claim 16, wherein the pseudo-control group includes at least some entities that each does not have a profile maintained by the social networking system.

19. The computer-implemented method of claim 16, wherein the data for the users in the control group include information describing an action performed by a user of the control group over the social networking system.

20. The computer-implemented method of claim 16, wherein the metric for effectiveness indicates an impact of the advertisement on awareness of a product or service promoted by the advertisement with respect to users of the social networking system.
